(19) United States
(12) Patent Application Publication
(10) Pub. No.: US 2007/0073715 A1
(43) Pub. Date: Mar. 29, 2007

(54) System and method of real time data accessing and initializing commands via wireless communication device

(75) Inventor: Andrew Tang, Newport Beach, CA (US)

Correspondence Address: Raymond Y. Chan, 108 N. Ynez Ave., #128, Monterey Park, CA, 91754, US

(73) Assignee: Zero Global, Inc.

(21) Appl. No.: 11/240,712

(22) Filed: Sep. 29, 2005

(51) Int. Cl. G06F 17/30

(52) U.S. Cl. 707/10

(57) ABSTRACT

A method of real time data accessing and initializing commands via a wireless communication device includes the steps of: storing unified data in a unified data repository from corporate databases; logically configuring the unified data to leverage data-driven components and to prepare the unified data to be routed for a wireless user; distributing the unified data into requested data when a request is sent by the wireless user; establishing a wireless network for the wireless user, wherein the requested data is transmitted in secured data packet through the wireless network; and wireless transmitting the requested data to the wireless user through the wireless network by the wireless communication device, such that the wireless user is able to real time access the unified data and to initialize command by the wireless communication device through the wireless network.

### BACKGROUND OF THE PRESENT INVENTION

1. Field of Invention

The present invention relates to a Customer Relation Management (CRM) technology, and more particularly to a system and method of real time data accessing and initializing commands via a wireless communication device, which provides uninterrupted wireless communicative management solutions for simultaneous corporate users worldwide.

2. Description of Related Arts

Customer Relation Management (CRM) system is commonly used in any business that manages the sales, marketing, billing, inventory and reporting efforts for people-interaction-management purpose. By using the CRM system, the business can project a better personal approach to their customers to enable the business to build a better relationship with their customers.

As shown in FIG. 1, a traditional CRM architecture includes a main database, a local database, and a wide-pipe stable connection as a physical connection to transmit data packets between the main database and the local database in order to maintain data sync integrity. The wide-pipe denotes a minimum of Kilobytes per second KB/s through a phone line up to Megabytes per second MB/s through high speed Internet such as DSL, Cable, T1, etc.

The CRM software has developed and is available in a web browser format as a pure-internet solution to enhance traveling managers to manage the business remotely, whereby sync is eliminated. However, the web security is one of the major issues for the web-based CRM for transmitting data through the Internet. In addition, the wide-pipe connection is stilled required in order to transmit extensive amounts of presentation layer data, such as graphics.

### SUMMARY OF THE PRESENT INVENTION

A main object of the present invention is to provide a system and method of real time data accessing and initializing commands via a wireless communication device, which provides uninterrupted wireless communicative management solutions for simultaneous corporate users worldwide, so as to enhance the global deployment capability.

Another object of the present invention is to provide a method of real time data accessing and initializing commands via a wireless communication device, which focuses on the elimination of non-valve add activities in order to create a quantum leap in business process enhancements, resulting in a more efficient and coherent procedure by identifying and assessing potential process improvements. In addition, the efficiency model promotes maximum system utilization through effective change management and post-implementation support.

Another object of the present invention is to provide a method of real time data accessing and initializing commands via a wireless communication device, which is architected to function across the unstable scattering nature of the wireless transmission medium.

Another object of the present invention is to provide a method of real time data accessing and initializing commands via a wireless communication device, wherein the wireless user is able to access and initialize command through the secure wireless communication by the secured data packet layers (SDPL). In addition, the wireless communication device requires biometric authentication to be accessed so as to enhance the security of the data transmission.

Another object of the present invention is to provide a method of real time data accessing and initializing commands via a wireless communication device, wherein the unified data repository forms a main data store where data form corporate databases are extracted and contained. The database schema is optimally designed through the tight coupling of a Core ER (Entity Relationship) design and a Vertical Module ER design.

Another object of the present invention is to provide a method of real time data accessing and initializing commands via a wireless communication device, wherein the logic server primarily handles business logic and leverages data-driven components to model most of the logic required by even the most sophisticated processes. The logic server also prepares the processed data to be routed to wireless users via a data distribution server.

Another object of the present invention is to provide a method of real time data accessing and initializing commands via a wireless communication device, wherein the data distribution server acts as the main catalyst for data transmission across wireless medium. Highly scalable and platform-independent, the data distribution server is optimized to function with the most up to data wireless infrastructure as well as its supporting protocols.

Another object of the present invention is to provide a method of real time data accessing and initializing commands via a wireless communication device, wherein the wireless communication device provides a real time data accessing for the wireless users worldwide.

Another object of the present invention is to provide a method of real time data accessing and initializing commands via a wireless communication device, wherein the wireless communication device contains intelligent logic to establish communication with the data distribution server. Data packets are sent via 2G (CDPD optimized) wireless protocol at 9.6 Kilobits per second.

Accordingly, in order to accomplish the above objects, the present invention provides a method of real time data accessing and initializing commands via a wireless communication device, comprising the steps of:
(a) storing unified data in a unified data repository from corporate databases, wherein data from the corporate databases are extracted and unified to form the unified data to be stored in the unified data repository;
(b) logically configuring the unified data to leverage data-driven components and to prepare the unified data to be routed for a wireless user;
(c) distributing the unified data into requested data when a request is sent by the wireless user;
(d) establishing a wireless network for the wireless user, wherein the requested data is transmitted in secured data packet through the wireless network; and
(e) wireless transmitting the requested data to the wireless user through the wireless network by the wireless communication device, such that the wireless user is able to real time access the unified data and to initialize command by the wireless communication device through the wireless network.

The present invention provides a system of real time data accessing and initializing commands comprising:
a unified data repository for storing unified data from data from corporate databases;
a logic server communicatively linked to the unified data repository to logically configure the unified data to leverage data-driven components and to prepare the unified data to be routed for a wireless user;
a data distribution server, which acts as a main catalyst for data transmission, communicating with the logic server for distributing the unified data into a requested data, wherein the data distribution server is arranged for wirelessly communicating with at least a wireless authority to establish a wireless network for transmitting the requested data in secured data packet; and
at least a wireless communication device wirelessly communicating with the data distribution server through the wireless network, wherein the wireless communication device comprises a client securing authentication for only allowing the wireless user who is authenticated to real time access the requested data from the data distribution server and to initialize command to the logic server by the wireless communication device through the wireless network.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram of a conventional CRM software design.

FIG. 2 is a schematic view of a system of real time data accessing and initializing commands according to a preferred embodiment of the present invention.

FIG. 3 is a schematic view of a unified data repository of the system of real time data accessing and initializing commands according to the above preferred embodiment of the present invention.

FIG. 4 is a schematic view of a logic server of the system of real time data accessing and initializing commands according to the above preferred embodiment of the present invention.

FIG. 5 is a schematic view of a secured data packet layer of the system of real time data accessing and initializing commands according to the above preferred embodiment of the present invention.

FIG. 6 is an interface of a method of real time data accessing and initializing commands according to the above preferred embodiment of the present invention.

FIG. 7 is a flow chart of the method of real time data accessing and initializing commands according to the above preferred embodiment of the present invention.

### DETAILED DESCRIPTION OF THE PREFERRED EMBODIMENT

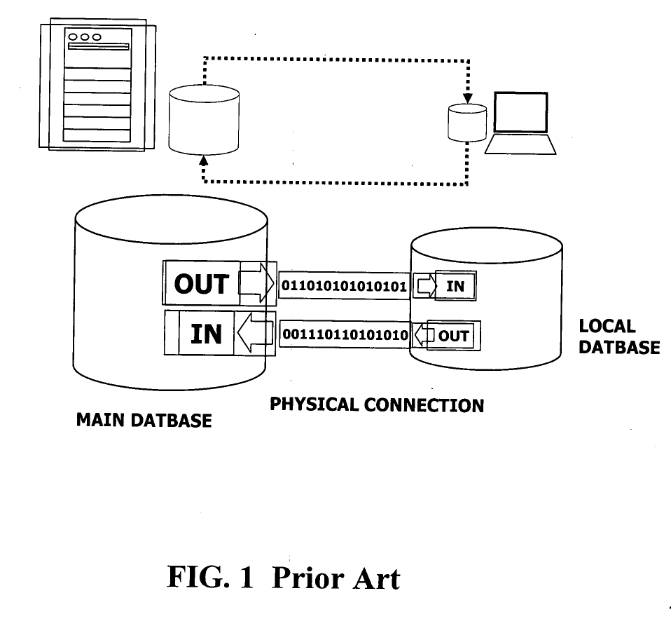

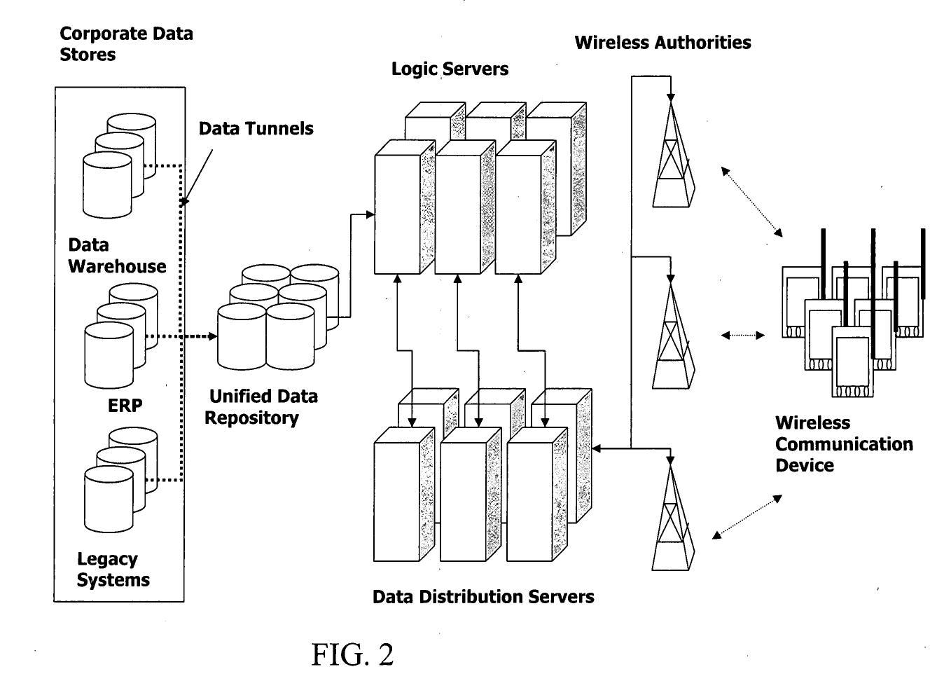

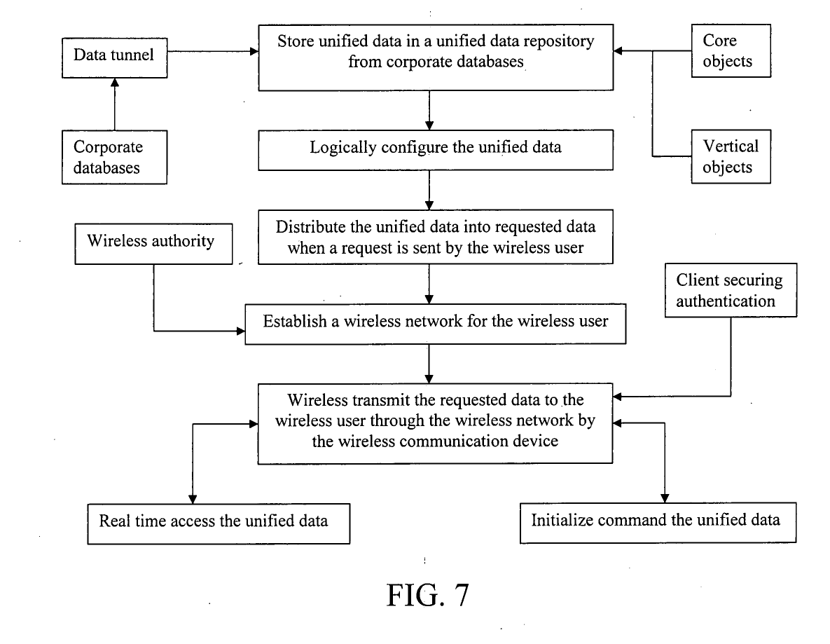

Referring to FIGS. 1 to 7, a method of real time data accessing and initializing commands via a wireless communication device according to a preferred embodiment is illustrated, wherein the method, as shown in FIG. 7, comprises the following steps.

(1) Store unified data in a unified data repository from corporate databases, wherein data from the corporate databases are extracted and unified to form the unified data to be stored in the unified data repository.

(2) Logically configure the unified data to leverage data-driven components and to prepare the unified data to be routed for a wireless user.

(3) Distribute the unified data into requested data when a request is sent by the wireless user.

(4) Establish a wireless network for the wireless user, wherein the requested data is transmitted in secured data packet through the wireless network.

(5) Wireless transmit the requested data to the wireless user through the wireless network by the wireless communication device, such that the wireless user is able to real time access the unified data and to initialize command by the wireless communication device through the wireless network.

The present invention provides a system of real time data accessing and initializing commands comprising a unified data repository for storing unified data from data from corporate databases, a logic server, a data distribution server, and at least a wireless communication device.

The logic server is communicatively linked to the unified data repository to logically configure the unified data to leverage data-driven components and to prepare the unified data to be routed for a wireless user.

The data distribution server, which acts as a main catalyst for data transmission, is communicating with the logic server for distributing the unified data into a requested data, wherein the data distribution server is arranged for wirelessly communicating with at least a wireless authority to establish a wireless network for transmitting the requested data in secured data packet.

The wireless communication device is wirelessly communicating with the data distribution server through the wireless network, wherein the wireless communication device comprises a client securing authentication for only allowing the wireless user who is authenticated to real time access the requested data from the data distribution server and to initialize command to the logic server by the wireless communication device through the wireless network.

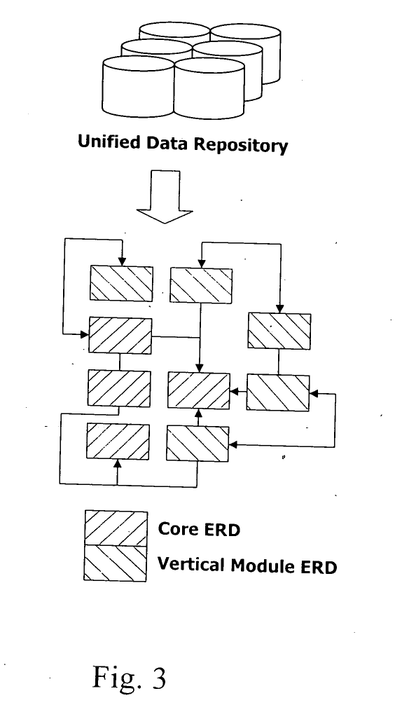

As shown in FIG. 3, the unified data repository for being the single source for data extraction is complied from two distinct components, the core objects and vertical objects. The core objects consist of underlying data structure common to all business entities. The vertical objects are complied for specific industries. The model is significantly superior to the existing system in that the customers are utilizing the application to its fullest rather than storing numerous unused tables and executing unqualified queries against the database. Having a modular structure also eases the process of upgrading.

The unified data repository is the main data store where data from corporate databases, such as data warehouse, ERP (Enterprise Resource Planning), legacy systems and so on, are extracted and contained. The database schema is optimally designed through the tight coupling of a Core ER (Entity Relationship) design plus a Vertical module ER design, such as telecommunication, consumer packaged goods, technology, software, financial/insurance, industrial and aerospace, energy, health care, Internet, real estate, media, etc, and supported RDBMS (Relational Database Management System) such as “Oracle 8”, “Microsoft SQL Server 6.5+”, “IBM DB2”, etc.

The unified data repository is communicatively linked to the corporate data stores through a data tunnel for enterprise data integration. The data tunnel is to integrating enterprise data with discrete autonomous systems. To be considered an enterprise application, the present invention is designed for simple integration rather that outsourcing to middleware software vendors. With this design, businesses will have a single application that manages the sales, marketing, billing, inventory, and reporting efforts all within on implementation cycle.

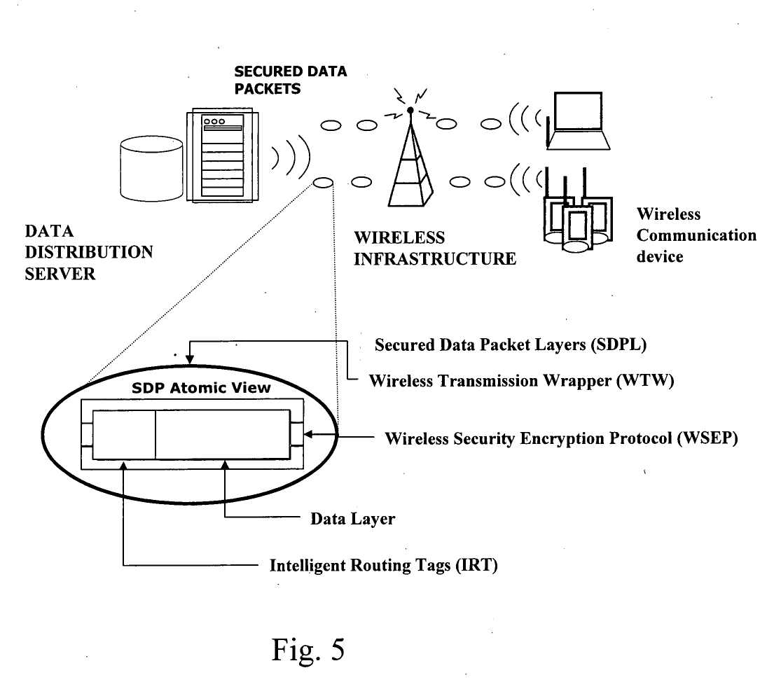

As shown in FIG. 5, the secured data packet comprises a secured data packet layer, a wireless security encryption protocol, a data layer, and an intelligent routing tag for securely transmitting the request data from the data distribution server to the wireless communication device through the wireless network.

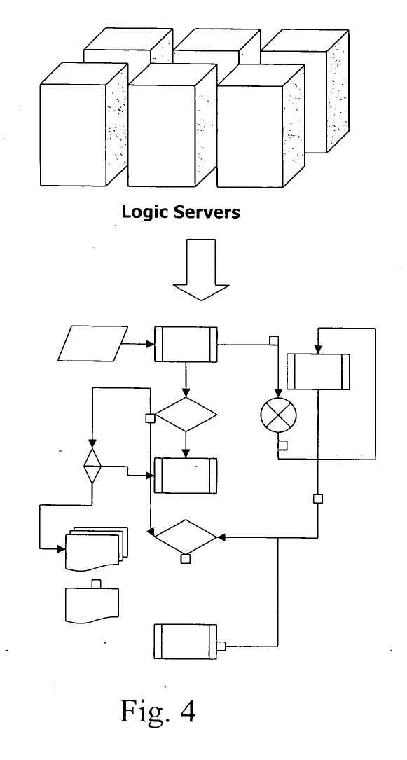

As shown in FIG. 4, the logic server primarily handles business logic and leverages data-driven components to model most of the logic required by even the most sophisticated processes. The logic server also prepares the processed data to be routed to wireless users via the data distribution server.

Accordingly, most existing CRM logic components are dependent upon the stored procedures of the underlying database(s). By superimposing a logical entity that will enhance the automated functionalities of CRM, a layer above the database system, the logic server will elevate the development of CRM functionalities far more rapidly than what the industry currently experiences. This allows the customers to administer and design logical elements to fit the business needs without costly configuration enhancements. The technologies used in the logic server include but not limited to “J2ME”, “XML”, “ActiveX”, “Jave 1.1x, Jave 2”, “RMI”, “LDAP”, “JDBC”, “COM”, “DCOM”, “ANSI C++”, and “HTTP”, and the supported operating systems for the logic server include but not limited to “Solaris 2.6 and up” and “Windows NT 4.0 SP 5+ and up”.

The data distribution server acts as the main catalyst for data transmission across wireless medium. Highly scalable and platform-independent, the data distribution server is optimized to function with the most up to data wireless infrastructure as well as its supporting protocols. The data distribution server is wireless compatibility of “AT&T”, “Bellsouth”, “Ericsson”, “Qualcomm”, “Lucent Technologies”, “MCI”, “Nortel”, “Nokia”, “Novatel”, “Nextel”, and “NTT DoCoMo”, and the supported wireless standards of the data distribution server include but not limited to “Mobile IP”, “CDMA”, “CDPD”, “GSM”, “HDML”, “WML”, and “WAP”.

The data distribution server will administer all extended communication with the mobile user (wireless user). Data will flow between the logic server and data distribution server to provide minimum effort and maximum value to mobile clients. This advanced feature greatly minimizes the requirement for users to input detail information. Also, the data distribution server submits only requested information through the wireless network rather than the existing data broadcasting techniques.

The wireless communication device provides real time data access for user worldwide at anytime. The solution is optimized to leverage the wireless infrastructure including but not limited to “CDMA”, “TDMA”, “CDPD”, “GSM”, “iDEN”, “3G”, “Mobile IP” and Satellite Capabilities. Supported client OS includes “Microsoft PocketPC”, “SUN J2ME”, “Qualcomm BREW”, “Palm OS” and “Motorola iDEN”. The client applications are also optimized to take full advantage of the processors implemented in these devices such as “StongARM”, “SH3” and “MIPS processors”. These new technologies are far more superior to simple telephony devices such as cell phones, which are incapable of addressing today's data-intensive requirements.

According to the preferred embodiment, the client securing authentication comprises a biometric authentication, such as fingerprint or other biometric information of the wireless user, stored in the wireless communication device for only allowing the wireless user who is authenticated to access the wireless communication device so as to real time access the unified data and to initialize command through the wireless network.

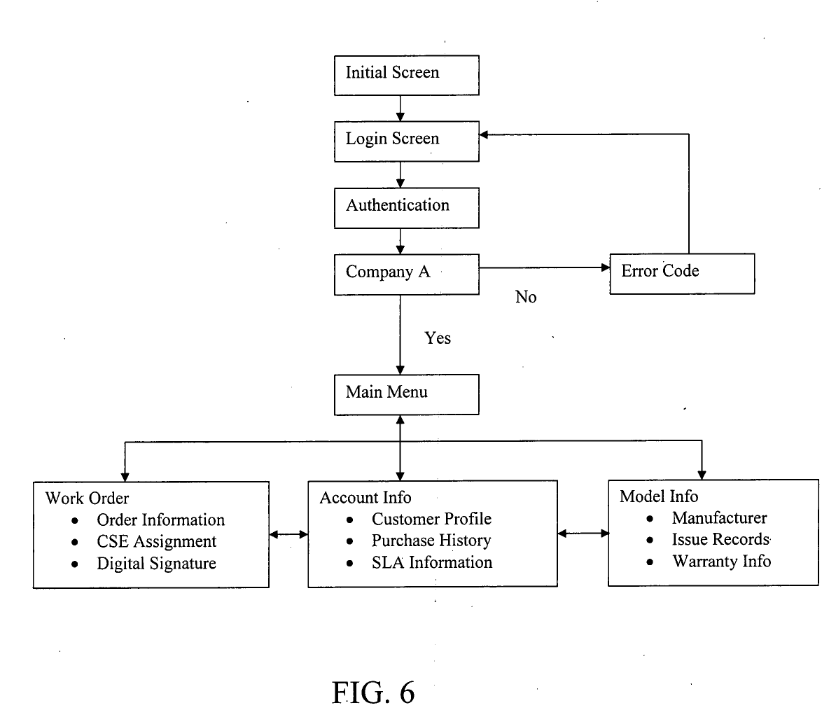

As shown in FIG. 6, the wireless user is able to access the unified data in the unified data repository by the wireless communication device through the wireless network. The wireless user would enter a personal authentication, such as a password and/or biometric, as a personal identification in order to communicatively link the wireless communication device to the data distribution server through the wireless network. Once the wireless user needs to access the unified data repository, the wireless user must send the request from the wireless communication device through the wireless network such that the requested data is distributed from the logic server and is sent from the data distribution server to the wireless communication device through the wireless network. In addition, the wireless user is able to initialize the command from the wireless communication device through the wireless network to the data distribution server. It is worth to mention that the client securing authentication is adapted to preset to have a plurality of confidential levels such that when the personal identification is input into the wireless communication device, the client securing authentication recognizes the wireless user that the wireless user is able to access the unified data repository at a predetermined confidential level. For example, a CEO of a company is able to access all unified data in the unified data repository when the corresponding personal identification. A manager may only allow accessing a second confidential level that some unified data in the unified data repository at the first confidential level cannot be accessed.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of real time data accessing and initializing commands via a wireless communication device, comprising the steps of:
(a) storing unified data in a unified data repository from corporate databases, wherein data from said corporate databases are extracted and unified to form said unified data to be stored in said unified data repository;
(b) logically configuring said unified data to leverage data-driven components and to prepare said unified data to be routed for a wireless user;
(c) distributing said unified data into requested data when a request is sent by said wireless user;
(d) establishing a wireless network for said wireless user, wherein said requested data is transmitted in secured data packet through said wireless network; and
(e) wireless transmitting said requested data to said wireless user through said wireless network by said wireless communication device, such that said wireless user is able to real time access said unified data and to initialize command by said wireless communication device through said wireless network.

2. The method as recited in claim 1 wherein, in step (a), said unified data repository is communicatively linked to said corporate databases through a data tunnel for integrating said data from said corporate databases with discrete autonomous systems thereof and for modularizing said data in said unified data repository.

3. The method, as recited in claim 1, wherein said unified data repository comprises core objects consisting of underlying data structure common to all business entities and vertical objects complied for specific industries allowing said wireless user utilizing an application to its fullest rather than storing numerous unused tables and executing unqualified queries against said corporate databases.

4. The method, as recited in claim 2, wherein said unified data repository comprises core objects consisting of underlying data structure common to all business entities and vertical objects complied for specific industries allowing said wireless user utilizing an application to its fullest rather than storing numerous unused tables and executing unqualified queries against said corporate databases.

5. The method as recited in clam 1, in step (e), further comprising a step of requesting a client securing authentication for only allowing said wireless user who is authenticated to real time access said unified data and to initialize command by said wireless communication device through said wireless network.

6. The method as recited in clam 2, in step (e), further comprising a step of requesting a client securing authentication for only allowing said wireless user who is authenticated to real time access said unified data and to initialize command by said wireless communication device through said wireless network.

7. The method as recited in clam 4, in step (e), further comprising a step of requesting a client securing authentication for only allowing said wireless user who is authenticated to real time access said unified data and to initialize command by said wireless communication device through said wireless network.

8. The method as recited in claim 1, in step (d), further comprising a step of communicatively linking to at least a wireless authority to establish said wireless network for transmitting said requested data in said secured data packet.

9. The method as recited in claim 4, in step (d), further comprising a step of communicatively linking to at least a wireless authority to establish said wireless network for transmitting said requested data in said secured data packet.

10. The method as recited in claim 7, in step (d), further comprising a step of communicatively linking to at least a wireless authority to establish said wireless network for transmitting said requested data in said secured data packet.

11. A system of real time data accessing and initializing commands comprising:
a unified data repository for storing unified data from data of corporate databases;
a logic server communicatively linked to said unified data repository to logically configure said unified data to leverage data-driven components and to prepare said unified data to be routed for a wireless user;
a data distribution server, which acts as a main catalyst for data transmission, communicating with said logic server for distributing said unified data into a requested data, wherein said data distribution server is arranged for wirelessly communicating with at least a wireless authority to establish a wireless network for transmitting said requested data in secured data packet; and
at least a wireless communication device wirelessly communicating with said data distribution server through said wireless network, wherein said wireless communication device comprises a client securing authentication for only allowing said wireless user who is authenticated to real time access said requested data from said data distribution server and to initialize command to said logic server by said wireless communication device through said wireless network.

12. The system, as recited in claim 11, further comprising a data tunnel communicatively linking said unified data repository to said corporate databases for integrating said data from said corporate databases with discrete autonomous systems thereof and for modularizing said data in said unified data repository.

13. The system, as recited in claim 11, wherein said unified data repository comprises core objects consisting of underlying data structure common to all business entities and vertical objects complied for specific industries allowing said wireless user utilizing an application to its fullest rather than storing numerous unused tables and executing unqualified queries against said corporate databases.

14. The system, as recited in claim 12, wherein said unified data repository comprises core objects consisting of underlying data structure common to all business entities and vertical objects complied for specific industries allowing said wireless user utilizing an application to its fullest rather than storing numerous unused tables and executing unqualified queries against said corporate databases.

15. The system, as recited in claim 11, wherein said client securing authentication comprises a biometric authentication stored in said wireless communication device for only allowing said wireless user who is authenticated to access said wireless communication device so as to real time access said unified data and to initialize command through said wireless network.

16. The system, as recited in claim 12, wherein said client securing authentication comprises a biometric authentication stored in said wireless communication device for only allowing said wireless user who is authenticated to access said wireless communication device so as to real time access said unified data and to initialize command through said wireless network.

17. The system, as recited in claim 14, wherein said client securing authentication comprises a biometric authentication stored in said wireless communication device for only allowing said wireless user who is authenticated to access said wireless communication device so as to real time access said unified data and to initialize command through said wireless network.

18. The system, as recited in claim 11, wherein said secured data packet comprises a secured data packet layer, a wireless security encryption protocol, a data layer, and an intelligent routing tag for securely transmitting said request data from said data distribution server to said wireless communication device through said wireless network.

19. The system, as recited in claim 14, wherein said secured data packet comprises a secured data packet layer, a wireless security encryption protocol, a data layer, and an intelligent routing tag for securely transmitting said request data from said data distribution server to said wireless communication device through said wireless network.

20. The system, as recited in claim 17, wherein said secured data packet comprises a secured data packet layer, a wireless security encryption protocol, a data layer, and an intelligent routing tag for securely transmitting said request data from said data distribution server to said wireless communication device through said wireless network.
